(19) United States
(12) Patent Application Publication
(10) Pub. No.: US 2002/0187348 A1
(43) Pub. Date: Dec. 12, 2002

(54) Absorbent materials

(76) Inventors: Adrian Jeremy Parker, South Duffield (GB); Jason Kenneth Holt, Acworth, GA (US)

Correspondence Address: BRACEWELL & PATTERSON, L.L.P., P.O. Box 61389, Houston, TX, 77208-1389, US

(21) Appl. No.: 10/087,678

(22) Filed: Mar. 1, 2002

Related U.S. Application Data
(60) Provisional application No. 60/283,041, filed on Apr. 11, 2001.

(30) Foreign Application Priority Data
Mar. 3, 2001 (GB) GB0105358.6

(51) Int. Cl. B32B 5/16; B32B 29/00

(52) U.S. Cl. 428/407; 428/403; 428/537.5

(57) ABSTRACT

The present invention is concerned with super absorbent polymers coated with a substantially impervious coating, super absorbent polymers coated with a substantially impervious coating which has been degraded to render it permeable, absorbent materials made from same, and methods of making same.

### BACKGROUND OF THE INVENTION

The present invention concerns novel super absorbent powders having impervious coatings, absorbent materials made using same, and methods of manufacture of same.

It has been highly desirable for a long time to manufacture absorbent materials, particularly those incorporating super absorbent materials such as swellable polymers. However, the methods of manufacture available, together with the materials available for the manufacturing process, have severely limited the nature of products which could be made.

Until now, the most widely used, inexpensive and simplest manufacturing techniques for absorbent materials have been wet processes involving the making of a non-woven web, for example a paper or board or other fibrous web or felt-like structure. However, such manufacturing processes are typically completely incompatible with the use of super absorbent materials such as swellable polymers since they would require the contacting of the polymers with liquids such as water. Over-swelling of the superabsorbent polymers can have severe consequences, and any swelling is undesirable since the liquid must be subsequently removed, which is at the least time-consuming and expensive. With many superabsorbent polymers it is typically near-impossible to dry them once they have been wet. Modified processes which claim to enable the use of super absorbent materials include those of U.S. Pat. No. 5,795,439 and U.S. Pat. No. 6,019,871 and references therein.

Air-laid paper manufacturing processes are nowadays very popular. In these, paper fibres are firstly produced in e.g. rolls by a wet process, dried and stored. The products are then pulverised in a hammer mill to release short fibres which, using an air transportation process, are laid onto a web. Other materials such as latex or bonding agents, are then added to the fibres on the web as desired, and the fibres then heat treated to produce the final product. Super absorbent polymers can be incorporated in such a manufacturing process, typically without too much swelling. However, swelling can occur when other aqueous substances are added to the air laid fibres. Also, due to the air-laid nature of the papers produced, particulate super absorbent polymers are not well distributed within the paper and can often escape during the manufacturing process, or can protrude (more so than in products of wet-laid processes of the present invention) from the surface of the finished product. In addition, the air-laid products are typically more expensive to produce than wet-laid products of the present invention and the best way to achieve a uniform distribution of super absorbent polymers in them appears to be the use of fibres of super absorbent polymer, which in itself is expensive. The present invention allows the incorporation of super absorbent polymers into the products of wet-laid processes, thus providing great advantage over processes which require the use of an air-laid manufacturing step. However, it should be noted that the super absorbent polymers of the present invention can also be used in air-laid manufacturing processes.

U.S. Pat. No. 5,795,439 discloses a process for the manufacture of a non-woven, wet-laid, superabsorbent polymer-impregnated structure, the process requiring the liquid used in it to be treated with a means for inhibiting the swelling of the superabsorbent polymer. The means used is in fact reduced temperature and salt. The efficacy of this would appear, however, to be somewhat limited and dependent upon the absorbent capabilities of the superabsorbent polymer—the more absorbent the polymer, the less use the process of U.S. Pat. No. 5,795,439. In particular, it suggests (see Example 3) that super absorbent polymer can be mixed with a 5% saline solution at 10 degrees Celsius for 30 minutes or an hour or longer before forming a final wet-laid product. This contrasts significantly with U.S. Pat. No. 6,019,871 which requires a mixing time of not more than 5 or 10 seconds.

U.S. Pat. No. 6,019,871 discloses a wet foam process for making non-woven webs from cellulose or synthetic fibres, which webs have as a component a super absorbent polymer. Swelling of the super absorbent polymer is inhibited by use of a dissolvable protective coating, sub-zero temperatures and salt. Once mixed with a fibre-containing slurry forming of the final fibrous web, i.e. removal of water and foam, is started within ten seconds, preferably within five seconds. This is obviously a complex process and the need for rapid removal of water and foam places severe limitations upon the overall process and the products made.

In addition, the above US patents require the use of low temperatures, whereas standard paper making processes (with which the present invention is compatible) typically require temperatures of at least 60 or 70 degrees centigrade. Such conventional paper manufacturing processes are not compatible with the use of lower temperatures since this reduction in process temperature causes numerous difficulties, particularly an increase in viscosity of manufacturing components, slower chemical reactions (such as bleaching and reaction with aluminium sulphate), and decreased solubility of impurities. In particular, the decreased solubility of water-soluble impurities means that a much more stringent water cleaning process must be employed to remove impurities (such as gums and adhesives etc.) since otherwise they will precipitate out during the manufacturing process, causing e.g. the coating of rollers with adhesive resulting in fouling and increased down-time of machinery. Alternatively, more fresh water must be employed in the manufacturing process, which is unacceptable on both cost and environmental grounds. Thus low process temperatures are not acceptable. Further, the prior art use of dissolvable protective coatings and salts results in a practically irreversible reduction in the capacity of the super absorbent polymer to absorb aqueous solutions. This is not a problem which affects the present invention.

The alternative to making non-woven materials is making woven materials using threads of super absorbent polymers. However, such threads are extremely expensive, the resulting absorbent materials typically having a cost per unit weight at least four times that of wet-laid products, for example US$ 12/kg as compared to US$ 2/kg. As such it is extremely desirable to avoid their use.

Other prior art which may be relevant to the present invention is known from U.S. Pat. No. 5,799,439, U.S. Pat. No. 5,620,742, GB 2291328 (U.S. Pat. No. 5,799,439), WO 00/67724, WO 95/13065 (U.S. Pat. No. 5,538,989), U.S. Pat. No. 4,508,760, U.S. Pat. No. 5,795,439 and U.S. Pat. No. 6,160,036.

The contents of each of the references discussed herein, including the references cited therein, are herein incorporated by reference in their entirety.

### BRIEF SUMMARY OF THE INVENTION

The present invention overcomes the prior art disadvantages, and according to a first aspect of the present invention there is provided a super absorbent polymer coated with a substantially impervious coating.

By “substantially impervious” is meant that the coating is impervious to, or substantially inhibits the contacting of the super absorbent polymer by, a chosen solvent, for example water. Thus, for example, a particle of super absorbent polymer having a water-impervious coating may take at least 30 minutes, for example at least 1, 2, 4, 6, 8 or 10 hours, to absorb the quantity of water that a similar non-coated particle of the super absorbent polymer would absorb in 30 seconds. Thus the rate of absorption or a solvent by a particle of the super absorbent polymer having an impervious coating may be slowed as compared to the rate of absorption by a similar uncoated particle by at least 10 times, for example at least 25, 50, 75, 100, 250, 500 or 1000 times.

Impervious coatings are made from materials such as parylenes (e.g. parylene C), ethyl cellulose and waxes and are typically polymeric substances which form a conformal, substantially “pinhole-free” coating.

Materials particularly useful as impervious coatings include acrylics, cellulose acetate, cellulose acetate butyrate, cellulose acetate phthalate, caseinates, chlorinated rubber, latex, dextrins, ethylene vinyl acetate, gelatin, hydrocarbon resins, methyl cellulose, microcrystalline wax, paraffin wax, polyethylene, polyvinyl acetate-alcohol-chloride, shellac, silicone, surfactants and waxes.

In particular, the material comprising the impervious coating may be highly insoluble, typically to all intents and purposes insoluble, in a chosen solvent absorbable by the super absorbent polymer and used in any subsequent method of making an absorbent material comprising the coated super absorbent polymer. A solvent is usually water, although of course different manufacturing processes may require the use of different solvents. For example, other solvents may include methanol, ethanol, other low alkyl alcohols, and combinations thereof.

It is also important that the impervious coating is readily degradable by means which will not impair the absorbency of the super-absorbent polymer. For example, the impervious coating may be degradable by mechanical damage such as crushing or heating. Naturally, the degradation method used will be dependent upon the physical characteristics of both the super absorbent polymer any other materials with which it is mixed such as fibres, and upon the physical characteristics of the material used to form the impervious coating. For example, some materials used to form the impervious layer may not undergo thermal degradation until temperatures are reached which would cause degradation to the superabsorbent polymer or e.g. fibres.

Degradation is also readily achieved by the use of ultrasonic sound—a beam of ultrasonic sound can be directed at the material so as to effect degradation of the impervious coating of the super absorbent polymer. The beam can be focussed to effect this degradation. Naturally, the sound pressure level (SPL) of the acoustic beam need be sufficient such that the impervious coating is degraded sufficiently to make it permeable. As with other methods of degradation, it may be performed so as to define an area, or zone, of super absorbent polymer having a degraded impervious coating contained within, contacting or adjoining, an area of superabsorbent polymer having a non-degraded impervious coating.

Other methods of degradation will be readily apparent to a person skilled in the art, and include e.g. the use of ultraviolet light or other electromagnetic radiation which causes degradation of the impervious coating.

The suitability of any chosen material for use in forming the impervious coating is readily determined firstly according to its physical characteristics, for example its solubility in the chosen solvent (above) such as water. A test batch of super absorbent polymer coated with the chosen material can then be prepared and the degradability of the impervious coating determined under chosen conditions, and thus the suitability of the chosen material for use as an impervious coating determined. This is an extremely simple and easy testing process and can thus be applied with minimal effort, readily allowing the testing of large numbers of materials in order to determine which of them is most suited for use in the present invention.

Methods for coating of Parylenes such as Parylene C are well known in the art. For example, Parylene Coating Services, Inc. (Texas, USA) provide a commercial parylene coating service, and produce a commercial parylene coating machine—the PCS 2530CM. Parylene coating is also well known in the art from e.g. U.S. Pat. No. 4,508,760, U.S. Pat. No. 6,119,895.

The use of parylene is also extremely advantageous insofar as when it is exposed to moisture it generates peroxides and ozone in quantities which are non-toxic to humans but which bactericidal.

The super absorbent polymer may be in particulate form, e.g. a powder.

As detailed below, the manufacturing methods of the present invention result in the degradation of the impervious coating to render it permeable, but only after phases of the manufacturing process involving the use of solvent absorbable by the super absorbent polymer have been completed.

Thus according to a second aspect of the present invention there is provided an absorbent material including a super absorbent polymer coated with a substantially impervious coating. This product is novel and is a useful intermediate, suitable for storage for prolonged periods with reduced sensitivity to e.g. moisture or humidity as compared to other prior art products incorporating super absorbent polymers. Upon the incorporation of the superabsorbent material into a final product, the impervious coating can be degraded to expose the super absorbent polymer, thereby providing the full absorbent properties of the superabsorbent material.

Thus according to a third aspect of the present invention there is provided an absorbent material including a super absorbent polymer coated with a substantially impervious coating which has been degraded to render it permeable.

According to a fourth aspect of the present invention there is provided a method for making an absorbent material, comprising incorporating in a material super absorbent polymer which has been coated with a substantially impervious coating.

The impervious coating may be treated to degrade it and render it permeable.

In particular, the absorbent material may be made by a wet process.

The absorbent material may be a wet laid web, for example a paper or board or other fibrous web or felt like structure. Other types of absorbent material which may be produced include air-laids, non-wovens, C-folded (air-laid paper, non-woven, films, and wet-laid paper), corrugated, plastic, poly foam or spray-coated solutions including latex, glue and guar gum.

Thus the absorbent material may comprise fibres. Fibres, as used herein, refer to any natural or synthetic fibre in either filament or staple form. The fibre is used to form the web structure. Any natural fibre or synthetic fibre or blends of both may be used. Exemplary fibres include polyester, polyethylene, polypropylene, polyvinyl alcohol, acrylic, acrylonitrile, nylon, polyurethane, rayon, tetrafluoroethylene, styrene-butadiene rubber, rubber, triacetates, polyamides, polyvinylidene chlorides, polyvinyl chloride, polybenzimidazole, cellulose acetate, cellulose, wood pulp fibre, and the like. The staple may be any length, but the greater the length, the greater the strength of the preform structure and therefore better handling from deliquification through drying. Staple is usually available in lengths of 0.25 to 5 cm. The most preferred lengths are from 0.5 to 1.25 cm. The denier per filament (dpf) is not critical. Preferably, a combination of polyester staple (1.5 dpf×1.25 cm) and cellulose acetate (1.8 dpf×0.6 cm) is used.

The impervious coating may be crushed to degrade it and render it permeable. In particular, this crushing may take place in or after a drying stage of a wet process. Generally speaking, the degradation of the impervious coating may be effected when the absorbent material is in a substantially dry form. For example, the super absorbent polymer having the non-degraded substantially impervious coating may be manufactured, stored, transported and manufactured into an end-product, and during the manufacturing of the end-product the substantially impervious coating may be degraded (for example by crushing), for example to define an area of absorbency within a larger area of material which is less absorbent. Thus the actual degradation step need not form part of the initial manufacturing process.

Super absorbent polymers are water insoluble, but water swellable, materials which are capable of absorbing many times their own weight of an aqueous solution. Examples of super absorbent polymers are members of three classes, namely, starch graft copolymers, cross-linked carboxymethylcellulose derivatives, and modified hydrophilic polyacrylates. Examples of such absorbent polymers are hydrolyzed starch-acrylonitrile graft copolymer, a neutralized starch-acrylic acid graft copolymer, a saponified acrylic acid ester-vinyl acetate copolymer, a hydrolyzed acrylonitrile copolymer or acrylamide copolymer, a modified cross-linked polyvinyl alcohol, a neutralized self-crosslinking polyacrylic acid, a cross-linked polyacrylate salt, carboxylated cellulose, and a neutralized cross-linked isobutylene-maleic anhydride copolymer. The superabsorbent polymer may be surface cross-linked. Naturally, the invention extends to the use of super absorbent polymers which do not fall within these example classes. Commercially available super absorbent polymers useable in the present invention include e.g. the Aqua Keep (RTM) range of products from Sumitomo Seika Chemicals Co., Ltd. (Osaka, Japan). Preferably the super absorbent polymer has a low surface area to volume ration for a given particle size in order that the quantity of coating material (which is typically quite costly) can be minimised. Other useful polymers are polyacrylates such as sodium polyacrylate formed from the copolymerisation of sodium, potassium and/or magnesium salts with the methyl ester of acrylic acid. Methyl methacrylate copolymerised with acrylamide is useful, for example at ratios of 1:99 to 99:1. Carboxyl methyl cellulose is also useful.

The absorbent materials made according to the method of the present invention are useful in a wide range of applications, essentially anything where it is desired to absorb quantities of water or aqueous solutions. In particular, uses are inserts for food packaging, feminine hygiene products, bed pads, diapers, and floor guards for bins. Other suitable products include cable wrap, incontinence pads, hygiene pads, and food packaging.

The degradation step used in the manufacturing process of the present invention also provides a great advantage, namely the ability to cause a manufactured material to be selectively absorbent in terms of having defined areas of absorbency. For example, if an absorbent material according to the present invention is formed in a first shape (such as a square) the degradation step (for example the application of pressure or heat) can be performed on only a part of that first shape so as to define a second shape within the first shape. Thus a square of superabsorbent material according to the present invention may only be absorbent in a circular region within the square.

Thus the methods of making an absorbent material according to the present invention may comprise making the absorbent material in a first shape, the degradation step to render the impervious coating permeable only being performed on a part of the first shape so as to define a second shape within the first shape.

The ability to have a single piece of material, particularly of a wet-laid material, formed without the subsequent addition of extra materials such as waxes, yet which has both absorbent and non-absorbent regions has not been previously suggested. Obviously, it is well known to cover materials with a masking layer such as wax to define absorbent and non-absorbent regions, but this does require the addition of the extra non-absorbent material. In addition, such extra non-absorbent materials are just provided as a surface layer and do not prevent wicking and suchlike within the material, meaning that once part of the material becomes wet, the water is able to wick across to other parts of the material which are covered by the non-absorbent material.

The present invention overcomes this problem since the non-absorbency is an intrinsic property of all of the super-absorbent polymer material which has a non-degraded impervious coating.

Thus a diaper or feminine hygiene product can be readily formed from material of the present invention having both absorbent and non-absorbent regions. For example, an absorbent region can be formed having a non-absorbent perimeter which prevents leakage. Such products are simpler and less expensive to manufacture, requiring fewer components and reducing the need for costly and complex manufacturing steps such as stitching, heat-sealing etc. They can also be substantially thinner and thus more discrete than existing products.

Other useful products which can be made using the absorbent materials of the present invention include e.g. absorbent paper sheets such as tissues such as toilet paper and kitchen roll having at least one ply of a superabsorbent material according to the present invention surrounded both above and below by at least one ply of absorbent paper such as an absorbent crepe paper.

The method of the present invention provides a number of substantial advantages. Firstly, the resultant product is less expensive than comparable woven products, and the manufacturing process is simpler and more versatile than other processes for making non-woven wet-laid products incorporating super absorbent polymers. Secondly, the resulting product can be made much thinner than existing comparable products, which in turn can result in increased converting efficiencies, lower freight costs, less down time in the manufacturing process (for example due to the creation of less dust by non-woven products as compared to woven products), and less handling (for example due to the thinness of the product, and the quantity that can be provided on a single roll). Thirdly, the products of the invention allow the packaging of more pieces per unit (due to longer lengths of roll, and greater quantities of absorbent material per unit volume). Fourthly, the thinner products of the present invention allow the manufacture of thinner products incorporating them, for example feminine hygiene products and diapers. Fifthly, since degradation of the impervious coating is effected after the absorbent material is substantially dry, i.e. after it has a defined shape, degradation can be restricted to certain areas of the absorbent material. Thus islands of absorbency can be created within a piece of absorbent material. This is particularly useful in the manufacture of feminine hygiene products and diapers.

The present invention by using discrete pieces (for example particles) of super absorbent polymer coated with a (degraded) impervious coating also avoids the problem encountered with existing products of the formation by super absorbent polymer of a gel plug, preventing fluid flow to and absorption by the rest of the absorbent core (see for example www.nonwovens.com)

The invention will be further apparent from the following description with reference to the several Figures of the accompanying drawings.

### BRIEF DESCRIPTION OF THE SEVERAL VIEWS OF THE DRAWINGS

FIG. 1 shows EX60 viewed by scanning electron microscope (SEM) at 18× magnification;

FIG. 2 shows EX60 viewed by SEM at 100× magnification;

FIG. 3 shows EX60 viewed by SEM at 200× magnification; and

FIG. 4 shows EX60 viewed by SEM at 1000× magnification.

### DETAILED DESCRIPTION OF THE INVENTION

As detailed in the following experiments, super absorbent powder was coated with various thicknesses of parylene and its water-absorbability determined over various time periods. The results show that the coated particles are substantially water-impermeable for long periods of time, the exact length of time being dependent upon the thickness of the layer of parylene deposited on the particles.

Coated particles were then mechanically degraded by crushing to creates fractures or fissures in the parylene coating, and the absorbability of the particles determined over time. The results of these experiments showed that the coating on the degraded (crushed) particles was highly permeable and that the particles could readily absorb water.

The above experiments were repeated, this time by mixing the coated super absorbent polymer particles in a paper slurry mix and making paper from it. It was found that the paper had normal water-absorbent properties. Paper which, subsequent to the completion of the manufacturing process, had been crushed to degrade the parylene coating on the super absorbent polymer particles was highly absorbent, substantially more so than the paper containing the particles with the non-degraded coating.

This increase in absorbency was specific to the regions of the paper which was crushed, allowing the manufacture of paper having regions of absorbency and hydrophobic regions which did not absorb significant quantities of water.

### Preparation of Coated Super Absorbent Polymer Particles

Super absorbent powder (herein “EX60”) consists, of a coating of parylene C on the super absorbent polymer Aqua Keep (RTM) SA55SX (Sumitomo Seika, Osaka, Japan).

2 grams of the raw super absorbent polymer SA55SX absorbs 50 ml of saline solution in 50 seconds, and has a total absorption capacity of 60 g/g and a bulk density of 0.72 g/ml. The polymer forms agglomerates of smaller particles, the agglomerates having an average particle size of 250-300 micrometres. Other polymers used in experiments but not detailed below are the SA60 Aqua Keep polymers, particularly SA60SL

Parylene C is a dimer (dichloro-di-p-xylylene) which, upon vaporisation in a coating process (Parylene Coating Services, Inc., Texas, USA—www.paryleneinc.com; Advanced Coating, CA, USA—www.advancedcoating.com) degrades to a monomer and forms a polycrystalline conformal substantially pinhole-free polymeric (poly monochloroparaxylylene) coating upon the SA55SX super absorbent polymer.

Other parylenes used in experiments but not detailed below are Parylene D and Parylene N.

Coating was effected by vapour deposition of parylene C upon the SA55SX for varying lengths of time to produce various batches of coated particles having different thicknesses of coating.

For example, a 2 micrometre thick coating of polymeric parylene C was achieved on SA55SX by blending 100 kg of parylene C per metric ton of SA55SX.

Other thicknesses of coating were achieved by blending parylene C and SA55SX at 143 kg per metric ton, 60 kg per metric ton and 15 kg per metric ton.

### Scanning Electron Microscopy

EX60 was studied by SEM using a Joel JSM 5600 LV SEM. This allowed the determination of the shape, size and structure of EX60 particles and the determination of the nature of the surface coating.

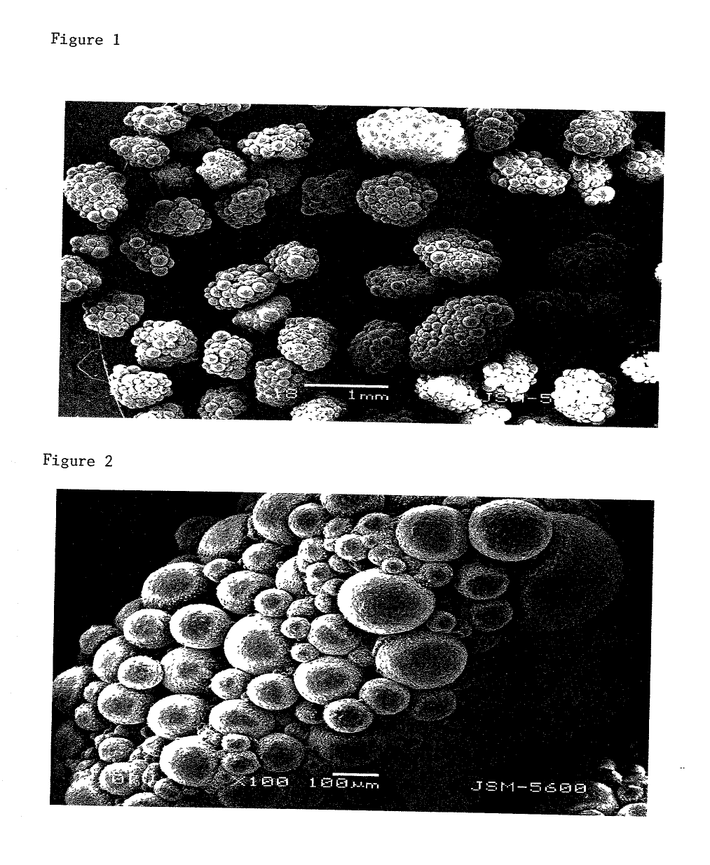

As can be seen from FIGS. 1 and 2, EX60 is a non-spherical slightly ovoid structure, individual particles having an average diameter of 100 micrometres.

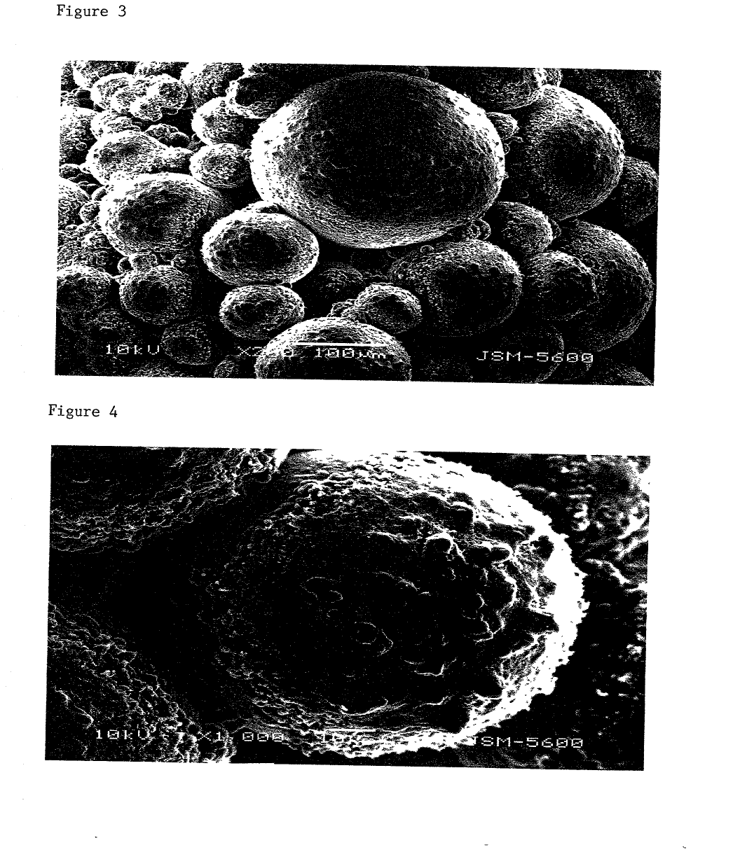

FIGS. 3 and 4 show the individual particles to be a slight ovoid shape with an average diameter of 100-150 micrometres.

### Water-Absorbency of EX60

The above preparations of parylene C-coated SA55SX were tested for the ability of the parylene C to prevent absorption of water by the SA55SX.

The 143 kg per metric ton preparation gave more than 9 hours of protection. The 100 kg per metric ton preparation gave at least 3.5 hours protection. The 60 kg per metric ton preparation gave 30-60 minutes protection. The 15 kg per metric ton preparation gave 15-30 minutes protection.

The amount of protection afforded by a given weight of impervious coating such as parylene C can be increased by for example reducing the variance in particle size about a given desired mean particle size. For example, it may be desirable to have a mean particle size of 250 micrometres with a standard deviation of about 17 micrometres. Thus a normal distribution of particle sizes about the mean size will result in 99.9% of all particles being between 200 and 300 micrometres in size. By reducing the standard deviation (i.e. reducing the variance) in particle size, not only is the proportion of smaller particles having a larger surface area to volume ration decreased (and therefore the mass of coating required per unit mass of particle decreased). In addition, it has been found that smaller particles are capable of agglomerating with the larger ones (see Figures) and preventing their complete coating with e.g. parylene C. These uncoated (or partially uncoated) particles are exposed sufficiently to make them capable of absorbing water. By reducing the number of smaller particles, these agglomerates form less frequently and so the absorbency of the end-product is reduced.

Thus reducing the variance in particle size results not only in the need for a reduced amount of coating per unit mass of particle, but also (and very surprisingly) in a decreased absorbency of those particles. For example, a reduction in the variance of particle size readily allows the use of half the above quantities of parylene C to provide a given period of time in which they do not absorb water.

Additional tests were performed as follows:

### Absorbency of the EX60 Powder

In order to determine how long it took for water to penetrate the coating of EX60, the super absorbent powder (SAP) EX60 was tested to see how long in minutes it would take to absorb a known quantity of distilled water. EX60 was weighed out in 1 g and 0.5 g quantities and dropped into beakers with 1000 ml and 500 ml of distilled water respectively and observed for 12 hours or until the powder had fully absorbed the liquid. The experiment was deemed finished when the powder had dispersed throughout the liquid and the liquid was a gel, with the ability not to “fall out” of the beaker when inverted. All of the experiments were performed in triplicate at room temperature.

The results are given in Table 1 and show that after 4 hours some of the powder had started to disperse to the bottom of the beakers. This was most prominent with the 1 g of EX60 in 1000 ml distilled water, where the bottom sixth of the vessel had become “gel-like”. Notably, there was no noticeable or significant absorption of water within the first 15 to 30 minutes, which is critical since this is typically the length of time for which the non-degraded imperviously coated super absorbent polymers will be exposed to the wet stages of a modem paper manufacturing process,

After 8 hours the 1 g EX60 in 500 ml distilled water, all of the liquid was present in a gel-like material, and the 1 g EX60 in 1000 ml distilled water was now almost three quarters gel.

Only the 1.0 g EX60 in 500 ml distilled water actually turned fully to a gel, all of the other samples of EX60 not having turned all of the distilled water into gel after 30 hours. After a period of over 60 hours the 0.5 g EX60 in 500 ml distilled water had still not fully dispersed throughout the liquid, although the samples were much more viscous and gel-like than after 10 hours.

Thus the absorption rate of water by the superabsorbent polymer of the non-degraded EX60 was very slow, showing that the coating is sufficiently impervious.

### Absorbency of the Degraded EX60 Powder

A sample of EX60 was then placed between two sheets of paper and rolled/crushed with a rolling pin for 30 seconds in order to degrade the impervious coating. 1.0 g EX60 was then added to 500 ml distilled water and the time taken to absorb the water recorded. After 5 hours nearly half of the distilled water had turned to gel, and after 12 hours all of the liquid had been converted to a gel-like matrix very similar to wallpaper paste. Notably, there was significant absorption of water during the initial 15 to 30 minute period, confirming that the degradation of the coating resulted in a significant increase in the rate of absorption of water by the super absorbent polymer.

Thus the degradation step causes the impervious layer to become permeable, readily allowing the absorption of water by the super absorbent polymer. The use of more severe degradation conditions such as the use of higher pressures in the crushing step can be expected to result in more significant increases in permeability of the impervious coating.

### Preparation of EX60 Into Paper

EX60 powder was incorporated into a pulp paper as follows:

Whatman filter paper (2 g) was dispersed in 2000 ml of distilled water and added to a Mark IIIC standard pulp disintegrator for 3000 counts. After “pulping” of the filter paper, 0.5 g of EX60 was added to the pulp mixture (25% w/w) and the pulp mixture added into a British Standard Sheet Papermaking Machine. The pulp material was compressed 5 times in the papermaking column, before the water was released from the column and the paper formed on the wire grid.

The wire grid was removed from the column and the paper pulp removed from the grid and placed between two weighted rings to prevent shrinkage of the paper. The paper was then dried for 24 hours at 28° C. while clamped.

The paper produced had an area of 189 cm², and was quartered evenly to give pieces each having an area of 47.1 cm². The quarters were then used to determine how much water could be absorbed, and were rolled with a rolling pin to degrade the impervious coating of the super absorbent polymer. The papers were then compared to a control of the original filter paper used. All experiments were performed in triplicate.

Distilled water was added to the samples in 2 ml aliquots via Gibson pipette until the paper could not retain any more liquid. The ability to retain water was tested by lifting the papers 30 cm above the bench and checking for any liquid dripped from the paper.

The standard filter papers with no EX60 retained 4 ml of distilled water with little dripping after being held 30 cm off the bench. However, after this no more water could be retained by the papers.

The crushed samples retained 8 ml of distilled water, before the super absorbent polymer started to react, by turning to a gel on the surface of the paper matrix. After 12 ml the paper still did not drip. At 24 ml the filter paper with EX60 still did not drip, the gel-like for of the EX60 was now very visible on the surface of the paper, however the paper matrix started to tear due to the weight of the liquid absorbed by the EX60. After another 2 ml the filter paper ripped.

Importantly, the coated super absorbent polymer did not swell during the manufacturing process, meaning that it can be used in bulk manufacturing processes without causing gumming-up of machines etc.

Thus paper made incorporating EX60 is capable of absorbing large quantities of water. As can be seen from the results, the quantity of water that can be absorbed results in mechanical damage (i.e. tearing) of conventional papers, and so an absorbent paper incorporating the coated super absorbent polymers of the present invention is preferably provided in the form of a mechanically strong paper, or for example as a multi-ply paper having at leat one inner ply consisting a paper incorporating the coated super absorbent polymer, and outer plies (i.e. at least one upper and lower ply) consisting a mechanically strong paper. In particular the mechanically strong paper may not be highly water absorbent in order that it retains its mechanical strength whilst the inner ply absorbs water.

In further experiments, paper was made using a faster manufacturing process than the one detailed above, the manufacturing process not resulting in the exposure of the coated super absorbent polymer to water for prolonged periods of time. This paper showed a significant difference in the amount of water it absorbed before and after degradation by crushing. Crushing was also performed in specific regions of sheets of paper, and the regions which had been degraded were substantially more absorbent than the non-degraded areas. This difference in absorbency was apparent for a prolonged period of time, demonstrating that such papers degraded in defined regions are ideal for containing and absorbing fluids within defined regions. In particular they are useful in feminine hygiene products, diapers and floor guards etc.

One problem encountered in the use of superabsorbent polymers is that they have a tendency to “gel block”. Gel blocking is the swelling of superabsorbent polymer that prevents fluid from passing through an absorbent structure and reaching more of the intended superabsorbent polymer.

For example, in the case of baby diaper, when fluid begins to contact the absorbent diaper, superabsorbent polymer located closest to the fluid entry point begins to swell. The fluid continues to flow for 10-15 seconds resulting in the first contacted superabsorbent polymer swelling, forming a jelly-like matrix. As this superabsorbent polymer is now swollen, the rest of the superabsorbent polymer in the diaper is blocked by the jelly-like matrix.

Currently, diaper manufacturers overcompensate for this problem by adding more superabsorbent polymer to the diaper to concentrate absorbency on the upper core (i.e. away from fluid entry points into the diaper).

The super absorbent polymers of the present invention coated with substantially impervious coatings can additionally have a soluble exterior coating of e.g. ethyl cellulose, or a gelatinous gum such as a soluble protein-carbohydrate coating and others well known in the art (see e.g. Arshady R., Microspheres and Microcapsules: A Survey of Manufacturing Techniques. 1: Suspension and Crosslinking., Polym. Eng. Sci., 30 (15), 1746-1758, 1989; Arshady R., Microspheres and Microcapsules: A Survey of Manufacturing Techniques. 2: Coacervation., Polym. Eng. Sci., 30 (15), 905-914, 1990; Arshady R., Microspheres and Microcapsules: A Survey of Manufacturing Techniques. 3: Solvent Evaporation., Polym. Eng. Sci., 30 (15), 915-924, 1990; Samuelov Y et al., Sustained Release of Drugs From Ethylcellulose-Polyethylene Glycol Films and Kinetics of Drug Release., J. Pharm. Sci., 68 (3), 325-329, 1979; Donbrow M., Friedman M., Enhancement of Permeability of Ethyl Cellulose Films for Drug Penetration., J. Phaim. Pharmac., 27, 633-646, 1975 and references therein).

The soluble coating on these superabsorbent polymers slows the process of swelling, reducing the blocking problem, and allowing fluid to reach the core therefore utilizing all of the superabsorbent polymer whilst not reducing the overall absorbency of the superabsorbent polymer.

This provision of a soluble coating can also be done with superabsorbent polymers other than those of the present invention.

The absorbent materials of the present invention can usefully be provided with an additional opaque film or laminate through which fluid flow can occur from outside of the absorbent material (e.g. from a foodstuff placed on it) into the absorbent material. The fluid flow can occur for example through perforations in the film or laminate or through pores in the film or laminate or other diffusion through it. It can be important to minimise any filtration of fluid by the film or laminate such that e.g. red blood cells and other such matter pass through the film or laminate and do not leave, or leave minimal, markings on the film or laminate. Thus meat can be placed on the absorbent material and any blood or other fluid or exudate which comes from the meat can be absorbed by the absorbent materials whilst leaving little or no staining on the upper film or laminate. This is not only visually pleasing to consumers but can also help in improving food hygiene.

This provision of an opaque laminate/film can also be done with absorbent materials incorporating superabsorbent polymers other than those of the present invention.

TABLE 1
Time taken by EX60 to absorb known amounts of liquid

| Mixture of EX60/distilled water | Time taken to absorb liquid | Mean |
|---|---|---|
| 0.5 g EX60/500 ml distilled water | >30 hours | N/A |
| 0.5 g EX60/500 ml distilled water | >30 hours | |
| 0.5 g EX60/500 ml distilled water | >30 hours | |
| 0.5 g EX60/1000 ml distilled water | >30 hours | N/A |
| 0.5 g EX60/1000 ml distilled water | >30 hours | |
| 0.5 g EX60/1000 ml distilled water | >30 hours | |
| 1.0 g EX60/500 ml distilled water | 600 minutes (10 hours) | 610 |
| | | minutes |
| 1.0 g EX60/500 ml distilled water | 600 minutes (10 hours) | |
| 1.0 g EX60/500 ml distilled water | 630 minutes (10 hrs 30) | |
| 1.0 g EX60/1000 ml distilled water | >30 hours | N/A |
| 1.0 g EX60/1000 ml distilled water | >30 hours | |
| 1.0 g EX60/l000 ml distilled water | >30 hours | |

TABLE 2
Amount of distilled water absorbed by the SAP filter papers

| Filter paper type | Amount of distilled water absorbed (ml) | Mean |
|---|---|---|
| Control 1 | 4 ml | 4 ml |
| Control 2 | 4 ml | |
| Control 3 | 4 ml | |
| Uncrushed powder | 26 ml | 25.3 ml |
| Uncrushed powder | 24 ml | |
| Uncrushed powder | 26 ml | |
| Crushed powder | 22 ml | 22.67 ml |
| Crushed powder | 22 ml | |
| Crushed powder | 24 ml | |

1. A super absorbent polymer coated with a substantially impervious coating.

2. A super absorbent polymer according to claim 1, wherein said substantially impervious coating is degraded to render it permeable.

3. An absorbent material including a super absorbent polymer coated with a substantially impervious coating.

4. An absorbent material according to claim 3, wherein said substantially impervious coating is degraded to render it permeable.

5. An absorbent material according to claim 3, wherein said absorbent material is formed in a first shape and said degraded substantially impervious coating is degraded so as to define a second shape within said first shape.

6. An absorbent material according to claim 3, wherein it additionally comprises non-woven fibres.

7. An absorbent material according to claim 6, wherein said non-woven fibres comprise paper or board fibres.

8. A method for making an absorbent material comprising incorporating in a first material a super absorbent polymer coated with a substantially impervious coating, and treating said substantially impervious coating to degrade it and render it permeable.

9. A method according to claim 8, wherein said absorbent material is made by a wet process.

10. A method according to claim 9, wherein said absorbent material is a wet laid web.

11. A method according to claim 10, wherein said absorbent material is selected from one of the group consisting of paper and board.

12. A method according to claim 8, wherein said super absorbent polymer is crushed to degrade said substantially impervious coating.

13. A method according to claim 12, wherein crushing takes place in a drying stage of a wet process.

14. A method according to claim 8, wherein said substantially impervious coating is degrade by a method selected from any of the group consisting of: heating, the application of ultrasound, and the application of electromagnetic radiation.

15. A method according to claim 8, wherein said absorbent material is made in a first shape, said degradation step to render said substantially impervious coating permeable only being performed on a part of said first shape so as to define a second shape within said first shape.

16. A super absorbent polymer according to claim 1, wherein said super absorbent polymer is in particulate form.

17. An absorbent material according to claim 3, wherein said super absorbent polymer is in particulate form.

18. A method according to claim 8, wherein said super absorbent polymer is in particulate form.
